(19) United States
(12) Patent Application Publication
(10) Pub. No.: US 2008/0098896 A1
(43) Pub. Date: May 1, 2008

(54) Dust collecting table

(76) Inventor: Yuan-Tai Cheng, Taichung (TW)

Correspondence Address: BRUCE H. TROXELL, SUITE 1404, 5205 LEESBURG PIKE, FALLS CHURCH, VA, 22041, US

(21) Appl. No.: 11/590,914

(22) Filed: Nov. 1, 2006

(51) Int. Cl. B01D 53/02

(52) U.S. Cl. 96/134

(57) ABSTRACT

A dust collecting table includes a box divided into a first chamber, a second chamber, a third chamber and a fourth chamber, a spark blocker installed in an upper portion of the second chamber, a movable cloth filter device installed in a lower portion of the second chamber, a blower set in the first chamber, and at least a screening device. As the blower is switched on, air is to be sucked from air inlet gates of the spark blocker to pass through the movable cloth filter device, the blower and the screening device orderly into the atmosphere, blocking sparks completely and achieving an effective filtration.

### BACKGROUND OF THE INVENTION

1. Field of the Invention

This invention relates to a dust collector, particularly a dust collecting table.

2. Description of the Prior Art

Metallic welding is very common in factories involving zinc welding, electric welding and heat treatment. Volatile fumes produced by welding may contain heavy metals, such as lead, cadmium, manganese, nickel and chromium, and these metals may cause various professional diseases to pose potential danger to human health. In order to protect persons exposed in such a contaminated environment, ventilation or wearing a proper respirator has been conventionally done so far. But, a lot of factories restricted by their structure cannot obtain good ventilation. Badly, a conventional ventilator with no screening function can merely expel the contaminated air elsewhere without isolating any metallic fumes. Although, some factories may use an one-layer or multi-layer industrial screen device for ventilating, but the screen is very easy to be clogged with oil and impurities produced during welding, having to replace with a new one or be cleaned very often if wishing to achieve an effective filtration. Moreover, the screen used industrially does not have a function of extinguishing sparks that may cause a fire or an air explosion once it is sucked into the interior of the equipment.

### SUMMARY OF THE INVENTION

The objective of this invention is to offer a dust collecting table.

The main characteristics of the invention are a box divided into a first chamber, a second chamber, a third chamber and a fourth chamber, a spark blocker, a movable cloth filter device, a blower set in the first chamber and at least a screening device. The third chamber is an opening room for a user to do welding work. The spark blocker installed in an upper portion of the second chamber is provided with an air inlet gate 221 located in its top to communicate with the third chamber. The movable cloth filter device installed in a lower portion of the second chamber is provided with a movable cloth filter. The fourth chamber contains the screening device and communicates with the first chamber. Therefore, as the blower is switched on, air is to be sucked from an air inlet gate 221 of the spark blocker to pass through the movable cloth filter device, the blower and the screening device orderly to the atmosphere. The spark blocker can block sparks effectively to prevent a fire or an air explosion from happening, and be extracted out easily to dump the spark residues. The cloth filter can be rotated timely to maintain a considerable fresh condition for filtering off oil and impurities that may clog the extractable filter of the screening device. Therefore, a fluent suction can be achieved and the screening device doesn't have to be replaced or cleaned often.

### BRIEF DESCRIPTION OF DRAWINGS

This invention is better understood by referring to the accompanying drawings, wherein:

FIG. 1 is a perspective view of a preferred embodiment of a dust collecting table in the present invention;

FIG. 2 is a front cross-sectional view of the preferred embodiment of a dust collecting table in the present invention;

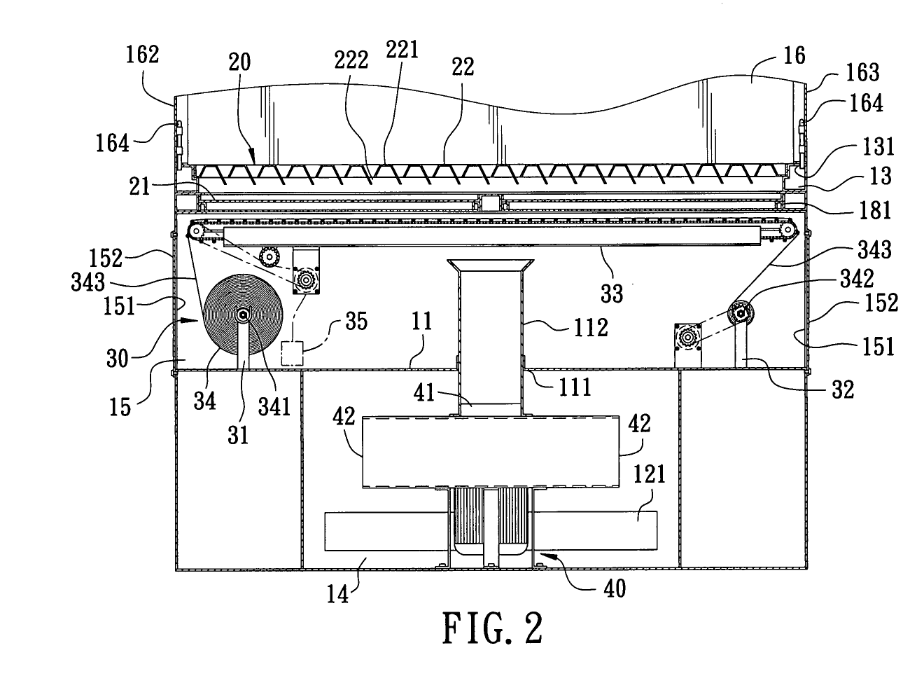

FIG. 3 side cross-sectional view of the preferred embodiment of a dust collecting table in the present invention; and

FIG. 4 is an exploded perspective view of a spark blocker of the preferred embodiment of a dust collecting table in the present invention.

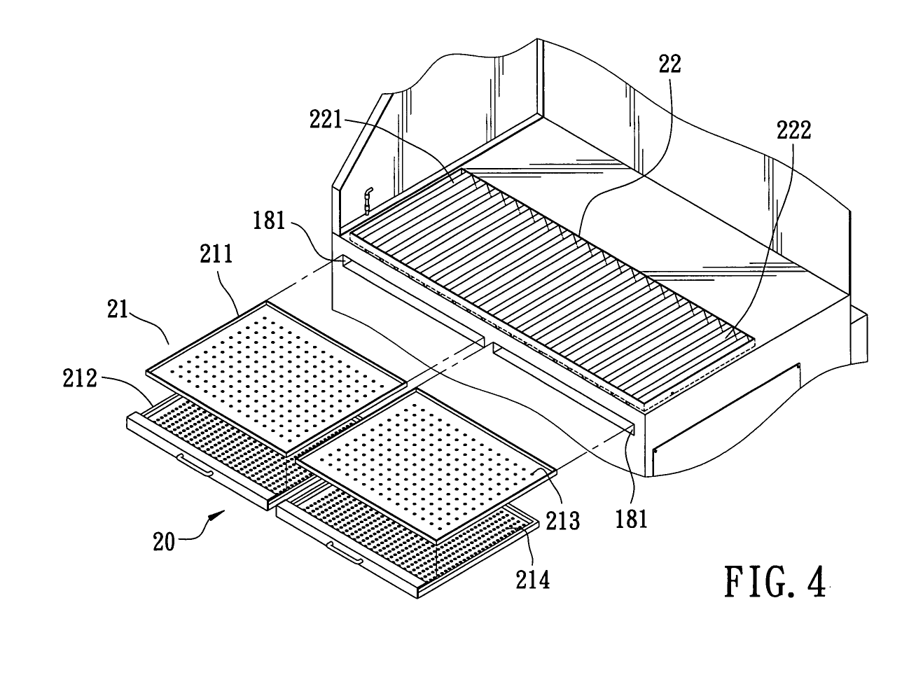

### DETAILED DESCRIPTION OF THE PREFERRED EMBODIMENT

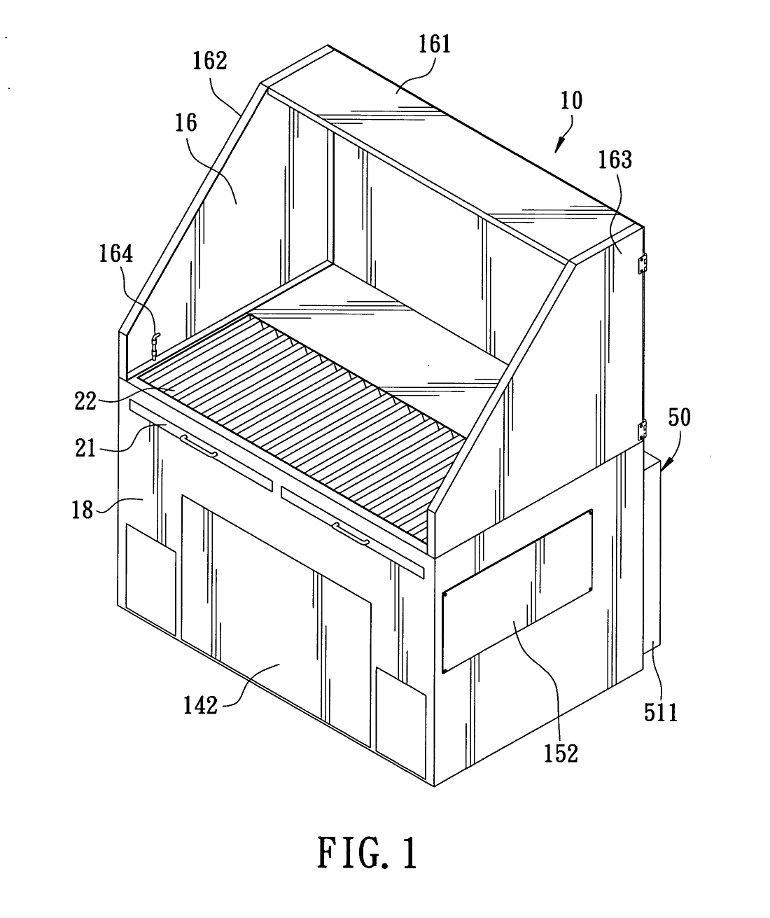

As shown in FIGS. 1˜3, a preferred embodiment of a dust collecting table in the present invention includes a box 10, a spark blocker 20, movable cloth filter device 30, a blower 40 and at least a screening device 50.

The box 10 is provided with a dividing plate 11, a rear dividing plate 12 and a positioning frame 13 to divide it into a first chamber 14 located in a bottom portion, a second chamber 15 located in an intermediate portion, a third chamber 16 in an upper portion and a fourth chamber 17 located in a rear portion behind the first chamber 14 and the second chamber 15 separated by the rear dividing plate 12. The dividing plate 11 is provided with a penetrating hole 111 bored at its center for a tube 112 to fit firmly therein to retain its two ends extending in the first chamber 14 and the second chamber 15 respectively. The first chamber 14 is provided with an opening 141 at the front side installed with a front cover 142 possible to be opened. The top of a front wall 18 of the box 10 is set with two plugging grooves 181 located horizontally adjacent beneath the lower edge of the positioning frame 13 and in the second chamber 15. The second chamber 15 is provided with two openings 151 cut on its two sidewalls installed respectively with a side cover possible to be opened. The third chamber 16 shaped trapezoid with its front side opened totally to form as an opening chamber is provided with a top wall 161 at its top, a left side door 162 and a right side door 163 respectively at its two sides. There is a positioning bolt 164 set on a preset position on interior walls of the left side door 162 and the right side door 163 respectively, corresponding to a positioning hole 131 bored on the positioning frame 13. The fourth chamber 17 is provided with a positioning projection 171 set at a preset location so as to define an upper chamber 172 and a lower chamber 173. The rear dividing plate 12 is provided with an air inlet 121 opened at a preset portion near its lower edge within the lower chamber 173 for communicating the first chamber 14 with the fourth chamber 17. In addition, the box 10 is provided with a rear wall 19 set with two dust collector grooves 174 at preset positions on its bottom edge for fitting with a dust collector 175 respectively.

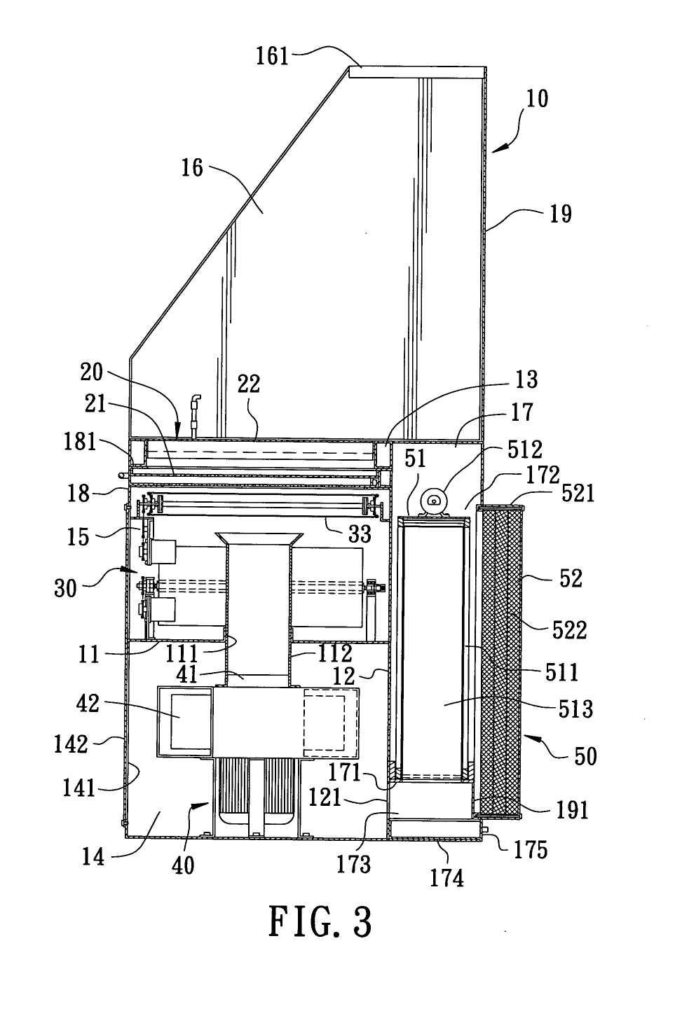

The spark blocker 20 installed seamlessly between the second chamber 15 and the third chamber 16, as shown in FIGS. 3˜4, is provided with two filtration units 21 and an air inlet unit 22. The filtration units 21 to be plugged into the plugging grooves 181 to communicate with the second chamber 15 are respectively provided with an upper receiving plate 211 and a lower receiving plate 212 made of metal. The upper receiving plate 211 is placed above the lower receiving plate 212 and spaced apart properly. Both the upper receiving plate 211 and lower receiving plate 212 are respectively provided with plural air vents 213 and 214 of a proper size. The air vents 213 bored in the upper receiving plate 211 are more thinly located than the air vents 214 bored in the lower receiving plate 212. The air inlet unit 22 installed between the third chamber 16 and the filtration units 21 is provided with plural air inlet gates 221 shaped trapezoid. Every two adjacent air inlet gates 221 overlap each other to form an air inlet passage 222.

The movable cloth filter device 30 installed inside the second chamber 15 is composed of a first winding base 31, a second winding base 32 located corresponding with the first winding base 31, a rolling table 33, a rolled cloth filter winder 34 and a timer 35. The first winding base 31 and the second winding base 32 are respectively set fixedly at two sides of the dividing plate 11. The rolling table 33 able to move circularly is fixed inside the second chamber 15 under the spark blocker 20. The rolled cloth filter winder 34 is composed of a first shaft 341, a second shaft 342 and a cloth filter 343. The cloth filter 343 is wound around the first shaft 341 that is fitted pivotally on the first winding base 31. The second shaft 342 fitted pivotally on the second winding base 32. The cloth filter 343 wrapped around the first shaft 341 can be pulled out from its free end to lie on and be conveyed by the rolling table 33 to wrap around the second shaft 342. The timer 35 is set at a preset position of the box 10 and connected with the rolling table 33 so as to control the rotating cycles of the rolled cloth filter winder 34.

The blower 40 installed inside the first chamber 14 of the box 10 is provided with a sucking opening 41 connected with the bottom end of the tube 112 of the dividing plate 11, and at least one air exit 42 (two in the preferred embodiment facing to two sidewalls of the box 10 respectively). Of course, the blower 40 can also be provided with a single air exit 42 preferably facing to the air inlet 121 of the rear dividing plate 12.

The screening device 50 (two in the preferred embodiment) installed inside the fourth chamber 17 is respectively provided with two vibrating filters 51 and an extractable filter 52. The vibrating filter 51 is provided with a frame 511, a vibrating motor 512 installed on the top of the frame 511 to keep the frame 511 shaken, and plural continuous tubular cloth filters 513 fitted within the frame 511. The frame 511 is fitted on the positioning projection 171 to keep the openings of the continuous tubular cloth filters 513 facing downwards, and sealed between the lower chamber 173 and an air exit 191 of the rear wall 19. The extractable filter 52 is provided with a frame 521 fixed at the air exit 191 of the rear wall 19, and at least one active carbon screen 522 fixed in the frame 521 to seal up the air exit 191. There are three active carbon screens 522 used in the preferred embodiment of the invention.

In using, as shown in FIGS. 1˜4, the blower 40 is first switched on to suck from the air inlet unit 22, so that electric welding work can be done in the third chamber 16. The contaminated air generated in the third chamber 16 is then sucked through the air inlet passages 222 of the spark blocker 20 to flow orderly through the air vents 213 and 214 of the upper receiving plates 211 and the lower receiving plates 212, the cloth filter 343 under the spark blocker 20 for a first filtration, the entry of the tube 112 of the dividing plate 11 into the blower 40. Next, it continues to run through the air exits 42 into the first chamber 14, and then, pass through the air inlet 121 of the rear dividing plate 12 and the continuous tubular cloth filter 513 on the frame 511 of the vibrating filter 51 to the air exit 191. Finally, it is to pass through the active carbon screens 522 of the extractable filter 52 to become clean air released into the atmosphere as expected. Furthermore, the timer 35 connected with the rolling table 33 can be preset with a period of time to prompt a user to check if the cloth filter 343 should be displaced partially or renewed completely so as to ensure the cloth filter 343 retained in fresh condition. And, the continuous tubular cloth filters 513 fixed on the frame 511 of the vibrating filter 51 are to be shaken by the vibrating motor 512 to keep the dust from attaching on them easily, but dropping to the dust collector 175 in the lower chamber 173 instead.

The invention has the following advantages as can be seen from the foresaid description.

1. The spark blocker 20 installed between the second chamber 15 and the third chamber 16 can effectively block sparks from being sucked into the box 10, preventing a fire or an air explosion from happening, and collect spark residue by the upper receiving plate 211 and the lower receiving plate 212, which are able to be extracted, convenient for dumping the residue.

2. The air inlet passages 222 formed among the air inlet gates 221 can help extinguishing sparks.

3. The continuous tubular cloth filters 513 shaken by the vibrating motor 512 keep dust from attaching easily on their interior walls but dropping to the dust collector instead, improving air mobility.

4. With the left side door 162 and the right side door 163 installed respectively at two sides of the third chamber 16, the two openings 151 cut respectively at two sides of the second chamber 15 and installed respectively with a movable side cover 152, and the opening 141 cut at the front side of the first chamber 14 and installed with a movable side cover 142, it is very convenient to disassemble or maintain the invention without difficulty.

While the preferred embodiment of the invention has been described above, it will be recognized and understood that various modifications may be made therein and the appended claims are intended to cover all such modifications that may fall within the spirit and scope of the invention.

What is claimed is:

1. A dust collecting table comprising:
a box provided with a dividing plate, a rear dividing plate and a positioning frame to divide it into a first chamber located in a bottom portion, a second chamber located in an intermediate portion, a third chamber in a top portion and a fourth chamber located in a rear portion, said dividing plate provided with a penetrating hole bored at its center for communicating with said first chamber and said second chamber, two plugging grooves located beneath said positioning frame at a top of a front wall of said second chamber, said fourth chamber provided with a positioning projection located at a preset position for dividing itself into an upper chamber and a lower chamber, an air inlet cut at a preset position of said rear dividing plate in said lower chamber for said first chamber to communicate with said fourth chamber, an air exit cut at said rear wall in said upper chamber;
a spark blocker installed seamlessly between said second chamber and said third chamber and provided with two filtration units and an air inlet unit, said filtration units able to be plugged into said plugging grooves to communicate with said second chamber hereunder, said air inlet unit fixed on a positioning frame and able to communicate with said third chamber above it;
a movable cloth filter device installed inside said second chamber and composed of a first winding base, a second winding base, a rolling table, a rolled cloth filter winder and a timer, said first winding base and said second winding base respectively set fixedly at two sides of an upper surface of said dividing plate, said rolling table fixed inside said second chamber under said spark blocker and able to move circularly, said rolled cloth filter winder composed of a first shaft, a second shaft and a cloth filter, said cloth filter wound around said first shaft that is fitted pivotally on said first winding base, said second shaft fitted pivotally on said second winding base, said cloth filter wrapped around the first shaft able to be pulled out from its free end to lie on and be conveyed by said rolling table to wrap around said second shaft, said timer set at a preset position of said box and connected with said rolling table so as to control the rotating cycles of said rolled cloth filter winder;
a blower installed inside said first chamber of said box and provided with a sucking opening for communicating with said penetrating hole of said dividing plate and at least one air exit; and
at least one screening device installed inside said fourth chamber to filtrate air sucked from said air inlet and blown out through said air exit by said blower.

2. A dust collecting table as claimed in claim 1, wherein said penetrating hole of said dividing plate is fitted fixedly with a tube retaining its one end in said second chamber and the other one connected with said sucking opening in said first chamber.

3. A dust collecting table as claimed in claim 1 wherein said first chamber is provided with an opening at the front side installed with a front cover possible to be opened and said second chamber is provided with two openings cut on its two sidewalls installed respectively with a side cover possible to be opened.

4. A dust collecting table as claimed in claim 1 wherein said third chamber shaped trapezoid with its front side opened totally to form as an opening chamber is provided with a top wall at its top, a left side door and a right side door respectively at its two sidewalls that are movable, said left side door and said right side door set respectively with a positioning bolt at a preset position on their interior walls corresponding with a positioning hole of said positioning frame.

5. A dust collecting table as claimed in claim 1, wherein said fourth chamber is provided with two dust collector grooves located at the bottom edge of said lower chamber for fitting with a dust collector respectively.

6. A dust collecting table as claimed in claim 1, wherein each of said filtration unit is provided with an upper receiving plate and a lower receiving plate placed under said lower receiving plate and spaced apart properly, both said upper receiving plate and said lower receiving plate respectively provided with plural air vents with a preset size, said air vents in said upper receiving plate located more thinly than those in said lower receiving plate.

7. A dust collecting table as claimed in claim 1, wherein said air inlet unit is provided with plural air inlet gates shaped trapezoid for overlapping each other adjacent to form an air inlet passage.

8. A dust collecting table as claimed in claim 1, wherein said blower is provided with an air exit facing to said rear dividing plate.

9. A dust collecting table as claimed in claim 1, wherein said blower is provided with two air exits facing to two sides of said box respectively.

10. A dust collecting table as claimed in claim 1, wherein said screening device is composed of two vibrating filters provided respectively with a frame filled with plural continuous tubular cloth filters and sealed between said lower chamber and said air exit with its opening facing downwards, and a vibrating motor installed above said frame.

11. A dust collecting table as claimed in claim 1 or 10, wherein an extractable filter installed outside said air exit is provided with a frame fixed outside said air exit and sealed with at least one active carbon screen corresponding to said air exit, said extractable filter able to be fitted in or extracted out through grooves of said frame.
